(19) United States
(12) Patent Application Publication
(10) Pub. No.: US 2014/0105163 A1
(43) Pub. Date: Apr. 17, 2014

(54) Communication Method and Apparatus

(71) Applicant: Huawei Device Co., Ltd., Shenzhen (CN)

(72) Inventors: Kecheng Yu, Shenzhen (CN); Zhiming Ding, Shenzhen (CN)

(73) Assignee: Huawei Device Co., Ltd., Shenzhen (CN)

(21) Appl. No.: 14/136,105

(22) Filed: Dec. 20, 2013

Related U.S. Application Data
(63) Continuation of application No. PCT/CN2012/076276, filed on May 30, 2012.

(51) Int. Cl. H04W 76/02

(52) U.S. Cl. CPC H04W 76/021
USPC 370/329

(57) ABSTRACT

The present invention discloses a communication method and apparatus. The method includes: an antenna extending apparatus receives a communication request from a mobile terminal; establishes an Internet Protocol (IP) tunnel with the mobile terminal according to the communication request; receives terminal information sent through the IP tunnel by the mobile terminal; completes, according to the terminal information, an initial connection process with a base station covering an area where the antenna extending apparatus is located; and forwards a packet between the mobile terminal and the base station, so that the mobile terminal is capable of communicating with the base station through the antenna extending apparatus. In the present invention, no complicated technology of interaction between heterogeneous networks needs to be used, communication quality is improved, and the problem that a mobile terminal, after being abroad, cannot directly interact with a domestic base station is solved.

### CROSS-REFERENCE TO RELATED APPLICATION

This application is a continuation of International Application No. PCT/CN2012/076276, filed on May 30, 2012, which is hereby incorporated by reference in its entirety.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates to the field of mobile communications, and in particular, to a communication method and apparatus.

### BACKGROUND

When being abroad, most people encounter a problem of high international roaming charges if they still make calls by using a phone card provided by a domestic telecommunication operator. In a solution provided in the prior art, a user can also make calls in other countries by using a domestic network, where it is only required that an attocell device accesses a notebook computer and a mobile phone is connected to the attocell device, so as to make a call by using a bluetooth headset.

In a process of making a call by using an attocell device, the attocell works as a micro base station, and therefore must have very low transmission power. In this case, it is easy to be disturbed by other devices, thereby worsening communication quality.

### SUMMARY

Embodiments of the present invention provide a communication method and apparatus, which can solve the problem of poor communication quality. The technical solutions are as follows.

A communication method includes: receiving, by an antenna extending apparatus, a communication request from a mobile terminal; establishing, by the antenna extending apparatus, an Internet Protocol (IP) tunnel with the mobile terminal according to the communication request; receiving, by the antenna extending apparatus, terminal information sent through the IP tunnel by the mobile terminal; completing, by the antenna extending apparatus according to the terminal information, an initial connection process with a base station covering an area where the antenna extending apparatus is located; and forwarding, by the antenna extending apparatus, a packet between the mobile terminal and the base station, so that the mobile terminal is capable of communicating with the base station through the antenna extending apparatus.

A communication method includes: sending, by a mobile terminal, a communication request to an antenna extending apparatus according to a preset IP address of the antenna extending apparatus; establishing, by the antenna extending apparatus, an IP tunnel with the mobile terminal according to the communication request; sending, by the mobile terminal, terminal information to the antenna extending apparatus through the IP tunnel, so that the antenna extending apparatus completes initialization ranging and basic capability negotiation processes according to the terminal information; and performing, by the mobile terminal, through the antenna extending apparatus, authentication with a base station covering an area where the antenna extending apparatus is located, and communicating with the base station through the antenna extending apparatus after the authentication is passed.

An antenna extending apparatus includes: a receiving module configured to receive a communication request from a mobile terminal; a tunnel establishing module configured to establish an IP tunnel with the mobile terminal according to the communication request, where the receiving module is further configured to receive terminal information sent through the IP tunnel by the mobile terminal; an initial connection module configured to complete, according to the terminal information, an initial connection process with a base station covering an area where the antenna extending apparatus is located; and a forwarding module configured to forward a packet between the mobile terminal and the base station, so that the mobile terminal is capable of communicating with the base station through the antenna extending apparatus.

A mobile terminal includes: a sending module configured to send a communication request to an antenna extending apparatus according to a preset IP address of the antenna extending apparatus; a tunnel establishing module configured to establish an IP tunnel with the antenna extending apparatus according to the communication request, where the sending module is further configured to send terminal information to the antenna extending apparatus through the IP tunnel, so that the antenna extending apparatus completes initialization ranging and basic capability negotiation processes according to the terminal information; an authentication module configured to perform, through the antenna extending apparatus, authentication with a base station covering an area where the antenna extending apparatus is located; and a communication module configured to communicate with the base station through the antenna extending apparatus after the authentication is passed.

Another aspect of the invention, an interface extending apparatus is provided. The interface extending apparatus comprises a receiving module configured to receive a connection command; a tunnel establishing module configured to establish an IP tunnel with a mobile terminal according to the connection command, so that after the IP tunnel is established, the mobile terminal completes an initial connection process with a base station in an area where the mobile terminal is located; a call module configured to send a call command to the mobile terminal through the IP tunnel, so that the mobile terminal forwards the call command to the base station; and a communication module configured to communicate with the base station through the mobile terminal.

Another aspect of the invention, a mobile terminal is provided. The mobile terminal comprises a receiving module configured to receive a communication request from an interface extending apparatus; a tunnel establishing module configured to establish an IP tunnel with the interface extending apparatus according to the communication request; an initial connection module configured to complete an initial connection process with a base station in an area where the mobile terminal is located; and a forwarding module configured to perform packet forwarding between the interface extending apparatus and the base station, so that the interface extending apparatus is capable of communicating with the base station through the mobile terminal.

An IP tunnel is established between an antenna extending apparatus and the mobile terminal, wherein the antenna extending apparatus is located in a territory different from that of a mobile terminal, so that the antenna extending apparatus uses the IP tunnel as a relay of communication between the mobile terminal and a base station, and therefore a signal of the base station logically extends abroad very well. Meanwhile, no complicated technology of interaction between heterogeneous networks needs to be used, communication quality is improved, and the problem that a mobile terminal, after being abroad, cannot directly interact with a domestic base station is solved.

### BRIEF DESCRIPTION OF THE DRAWINGS

To describe the technical solutions in the embodiments of the present invention more clearly, the following briefly introduces the accompanying drawings required for describing the embodiments of the present invention. The accompanying drawings in the following description show merely some embodiments of the present invention, and persons of ordinary skill in the art may still derive other drawings from these accompanying drawings without creative efforts.

FIG. 1 is a flowchart of a communication method according to an embodiment of the present invention;

FIG. 2A and FIG. 2B are flowcharts of a communication method according to an embodiment of the present invention;

FIG. 3A and FIG. 3B are flowcharts of a communication method according to an embodiment of the present invention;

FIG. 4 is a flowchart of a communication method according to an embodiment of the present invention;

FIG. 5 is a flowchart of a communication method according to an embodiment of the present invention;

FIG. 6 is a schematic structural diagram of an antenna extending apparatus according to an embodiment of the present invention;

FIG. 7 is a schematic structural diagram of a mobile terminal according to an embodiment of the present invention;

FIG. 8 is a schematic structural diagram of an interface extending apparatus according to an embodiment of the present invention; and

FIG. 9 is a schematic structural diagram of a mobile terminal according to an embodiment of the present invention.

### DETAILED DESCRIPTION

To make the objectives, technical solutions, and advantages of the present invention more comprehensible, the following further describes the embodiments of the present invention in detail with reference to the accompanying drawings.

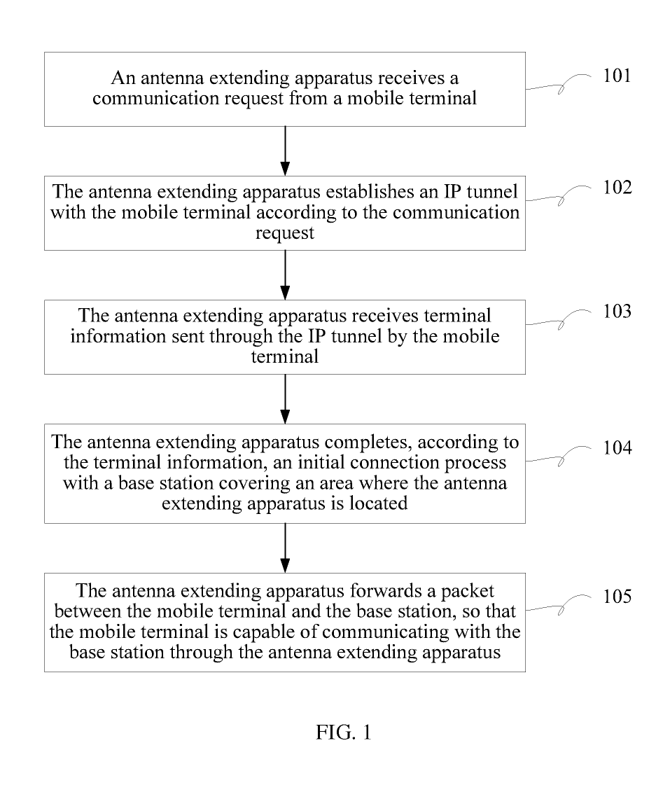

FIG. 1 is a flowchart of a communication method according to an embodiment of the present invention. The executive body of this embodiment is an antenna extending apparatus. Referring to FIG. 1, this embodiment includes the following steps.

101: An antenna extending apparatus receives a communication request from a mobile terminal.

102: The antenna extending apparatus establishes an IP tunnel with the mobile terminal according to the communication request.

103: The antenna extending apparatus receives terminal information sent through the IP tunnel by the mobile terminal.

104: The antenna extending apparatus completes, according to the terminal information, an initial connection process with a base station covering an area where the antenna extending apparatus is located.

105: The antenna extending apparatus forwards a packet between the mobile terminal and the base station, so that the mobile terminal is capable of communicating with the base station through the antenna extending apparatus.

In this embodiment, the antenna extending apparatus establishes the IP tunnel with the mobile terminal, and a packet is transmitted between the antenna extending apparatus and the mobile terminal by using the IP tunnel, so that after receiving the terminal information, the antenna extending apparatus can act as an agent of the mobile terminal to perform the initial connection process with the base station, and after the initial connection process, the antenna extending apparatus acts as a relay between the mobile terminal and the base station, and converts a received packet and forwards the converted packet.

In the method provided in this embodiment, the IP tunnel is established between the antenna extending apparatus, located in a country different from that of the mobile terminal, and the mobile terminal, so that the antenna extending apparatus uses the IP tunnel as a relay of communication between the mobile terminal and the base station, and therefore a signal of a domestic base station logically extends abroad. Meanwhile, no complicated technology of interaction between heterogeneous networks needs to be used, communication quality is improved, and the problem that a mobile terminal, after being abroad, cannot directly interact with a domestic base station is solved.

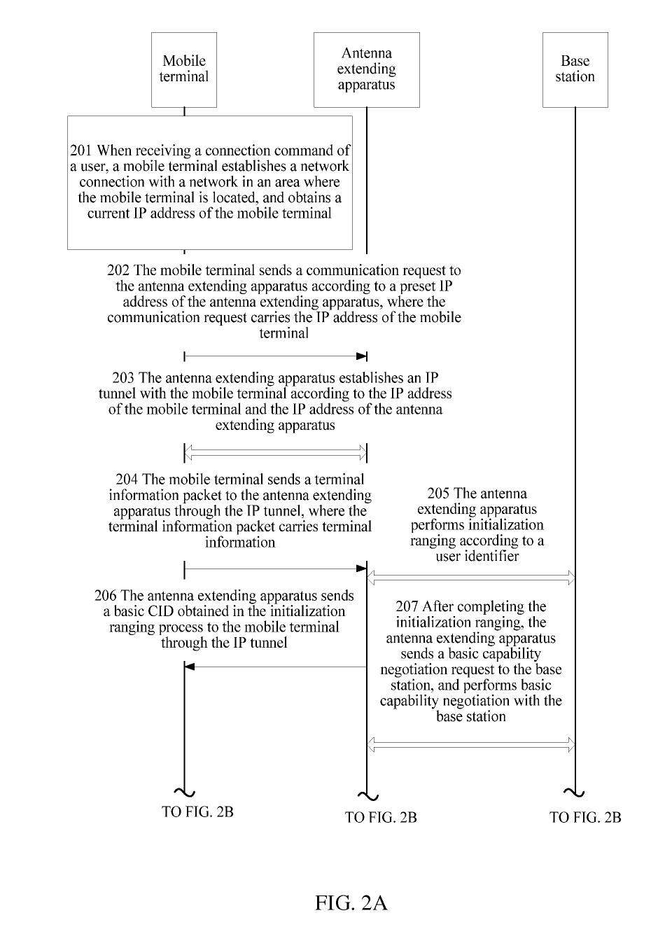

FIG. 2A and FIG. 2B are flowcharts of a communication method according to an embodiment of the present invention. Interactive bodies of this embodiment are a mobile terminal, an antenna extending apparatus, and a base station, where the mobile terminal and the antenna extending apparatus are located in different countries, for example, the antenna extending apparatus may be located in China, while the mobile terminal may be located outside China, and the base station refers to a base station covering an area where the antenna extending apparatus is located. Referring to FIG. 2A and FIG. 2B, this embodiment includes the following steps.

201: When receiving a connection command of a user, a mobile terminal establishes a network connection with a network in an area where the mobile terminal is located, and obtains a current IP address of the mobile terminal.

The connection command is a command used to establish an IP tunnel between the mobile terminal and the antenna extending apparatus.

In this embodiment, the mobile terminal is located abroad; when a user intends to make a call from a foreign country to the home country of the user by using the mobile terminal, the user triggers the connection command, where the user may specifically trigger the connection command in any one of the following manners: (1) the mobile terminal provides an operation interface to the user, where the operation interface displays a “connect” option, and when it is detected that the user selects the “connect” option, the user triggers the connection command, and the mobile terminal receives the connection command; and (2) the user dials a number, and when the mobile terminal detects that the number dialed by the user is started with a specified area code, the connection command is triggered, and the mobile terminal receives the connection command, where the specified area code is an area code of an area where the antenna extending apparatus is located.

When the mobile terminal receives the connection command of the user, the mobile terminal automatically scans a WiFi hotspot, and performs WiFi authentication with the scanned WiFi hotspot, and when the authentication is passed, the mobile terminal establishes a network connection with a network in the area where the mobile terminal is located. The WiFi hotspot may be a WiFi access point (AP). Persons skilled in the art may learn that, scanning a WiFi hotspot includes: actively sending, by the mobile terminal, a probe request frame, where the probe request frame may be broadcast; or receiving a WiFi beacon frame periodically broadcast by a WiFi AP. In this way, the mobile terminal can discover a WiFi AP around the mobile terminal, and then the mobile terminal is associated with the AP, so that the mobile terminal establishes a connection with a network in the area where the mobile terminal is located, which is not described here again.

Exemplarily, the mobile terminal selects, from the scanned WiFi hotspot, a free WiFi AP for connection, thereby avoiding the WiFi authentication process.

202: The mobile terminal sends a communication request to the antenna extending apparatus according to a preset IP address of the antenna extending apparatus, where the communication request carries the IP address of the mobile terminal.

In this embodiment, the antenna extending apparatus may be placed domestically. Exemplarily, the antenna extending apparatus may be placed at the home or workplace of the user or other places, and is connected to the Internet through a home gateway; because the antenna extending apparatus can obtain a fixed IP address, the fixed IP address of the antenna extending apparatus is preset on an external device, so that the external device accesses the antenna extending apparatus according to the fixed IP address, and in this embodiment, the external device is a mobile terminal.

203: The antenna extending apparatus establishes an IP tunnel with the mobile terminal according to the IP address of the mobile terminal and the IP address of the antenna extending apparatus.

Exemplarily, before step 203, the method further includes: performing, by the mobile terminal, authentication with a home gateway of the network where the antenna extending apparatus is located; and performing step 203 when the authentication is passed. The authentication may be performed by the mobile terminal according to a pre-stored password or key, and the authentication process is the same as a process of authentication with a home gateway in the prior art, which is not described here again.

In this embodiment, the mobile terminal may establish the IP tunnel with the antenna extending apparatus, where one end of the IP tunnel is the IP address obtained by the mobile terminal through step 201, while the other end of the IP tunnel is the IP address of the antenna extending apparatus, where the IP address is a public network IP address. The IP tunnel may be an IP security encapsulation (IPSec) tunnel, and the IP tunnel is used to transmit a packet between the mobile terminal and the antenna extending apparatus.

204: The mobile terminal sends a terminal information packet to the antenna extending apparatus through the IP tunnel, where the terminal information packet carries terminal information.

In this embodiment, after the mobile terminal establishes the IP tunnel with the antenna extending apparatus, the mobile terminal carries the terminal information in the terminal information packet and sends the terminal information packet to the antenna extending apparatus, where the terminal information includes a user identifier and terminal capability information, so that the antenna extending apparatus can start to work according to the received terminal information. At this time, the antenna extending apparatus is considered as an agent of the mobile terminal. The user identifier includes an international mobile equipment identification number (IMEI), or an international mobile subscriber identification number (IMSI). The terminal capability information includes hardware information, software information, network features, and browser features of the terminal, and specific function information of a terminal in this type.

Specifically, the antenna extending apparatus receives the terminal information packet sent through the IP tunnel by the mobile terminal, where the terminal information packet carries the terminal information; and the antenna extending apparatus decapsulates the terminal information packet, to obtain the terminal information.

205: The antenna extending apparatus performs initialization ranging according to the user identifier.

An initialization ranging process is a process of obtaining a clock offset and adjustment power, so that the mobile terminal can be precisely synchronized with a base station on the time, and has proper transmission power. The user identifier in this embodiment is a Media Access Control (MAC) address of an abroad mobile terminal.

The initialization ranging includes: sending, by the antenna extending apparatus, an initial ranging request to the base station according to the user identifier, and receiving an initial ranging response sent by the base station, where the initial ranging request carries the user identifier, and the initial ranging response carries a basic connection identifier (CID) allocated by the base station to the terminal, where the CID is a 16-bit value, and is used to authenticate a transmission connection and uplink and downlink management connections, and each transmission connection has a unique CID, and in addition, the initial ranging response further carries a priority management CID, a radio power level adjustment, a time offset adjustment, and so on.

206: The antenna extending apparatus sends the basic CID obtained in the initialization ranging process to the mobile terminal through the IP tunnel.

When the mobile terminal receives the basic CID, the base station allocates a dedicated initial ranging time period to the mobile terminal according to the allocated basic CID. In this time period, the mobile terminal may send another initial ranging request message, which carries power adjustment information and clock adjustment information, to the antenna extending apparatus by using the basic CID, and the initial ranging request message is forwarded by the antenna extending apparatus to the base station. Furthermore, in step 206, the antenna extending apparatus further sends a priority management CID to the mobile terminal.

207: After completing the initialization ranging, the antenna extending apparatus sends a basic capability negotiation request to the base station, and performs basic capability negotiation with the base station, so that the base station is ready to attach to an access service network-gateway (ASN-GW), so as to notify the ASN-GW that a terminal is to perform initial network access.

The basic capability negotiation request carries the basic CID and capability information of the mobile terminal. Furthermore, the basic capability negotiation request message further includes an authentication method that is supported by the mobile terminal and the base station and is used for extensible authentication protocol (EAP) authentication, a service information queue (SIQ), bandwidth allocation support, an accessed network service provider identifier (NSP ID), a security negotiation parameter, and a keyed-hash message authentication code (HMAC)/control mobile attenuation code (CMAC). The capability negotiation process is in the prior art, which is not described in the present invention.

208: The mobile terminal performs, through the antenna extending apparatus and the base station covering an area where the antenna extending apparatus is located, an EAP authentication process with an authentication server, and when the authentication is passed, both the mobile terminal and the base station obtain first security information.

In this embodiment, the first security information is an authentication key (AK) and a temporary EAP key (TEK), where the AK is generated by negotiation between the base station and the mobile terminal in the EAP authentication process, and the TEK is generated and allocated by the base station, and a plurality of TEKs may exist, and is used to protect subsequent communication between the mobile terminal and the base station. The base station uses the AK to protect transmission of the TEK. The protection means encryption or data integrity protection, or means both encryption and data integrity protection.

It should be noted that, in this EAP process, the terminal directly interacts with the authentication server, and the antenna extending apparatus only performs transparent transmission instead of acting as an agent. The EAP process is a unique process in which the antenna extending apparatus cannot be used as an agent of the mobile terminal to perform execution, as it is impossible for information of a subscriber identity module (SIM) such as a key generating algorithm and information of a generated key to be copied to the antenna extending apparatus. The SIM has a globally unique SIM card identification number and 16-bit key data Ki, and if the information of the SIM card is copied to the antenna extending apparatus, it means that the SIM card of the mobile terminal is invalid at the same time, and the mobile terminal cannot complete a subsequent network access process. Moreover, in the Worldwide Interoperability for Microwave Access (WiMAX) specification, the time for the whole EAP authentication process is generally limited to 5 minutes. Therefore, in this process, the antenna extending apparatus acts as a relay of the mobile terminal and the base station, and is configured to transmit a management message pair required for authentication of the two parties.

In an actual network, an authenticator and an authentication server (AS) are further set behind the base station. To describe the present invention briefly, functions of the authenticator and the AS are considered as functions of the base station, and only the base station is drawn in the accompanying drawing. In the 802.16 air interface protocol, description is also made in the same manner: all functions of a network side belong to functions of a base station.

The EAP process is a WiMAX standard network access process, which is not described again.

209: The mobile terminal sends the first security information to the antenna extending apparatus.

210: The antenna extending apparatus acts as an agent of the mobile terminal, performs key negotiation and distribution according to the first security information, and obtains second security information allocated by the base station.

In this embodiment, the second security information is a security association (SA), and the SA is a security information set shared for network communication security. The SA at least includes the TEK.

It should be noted that, the difference between the key negotiation and distribution process in this embodiment and the key negotiation and distribution process performed by the mobile terminal in the prior art only lies in that, two interactive parties of key negotiation and distribution are the antenna extending apparatus and the base station, where the antenna extending apparatus acts as the agent of the mobile terminal.

211: The antenna extending apparatus forwards the second security information obtained from the base station to the mobile terminal.

In this embodiment, the antenna extending apparatus sends the SA obtained from the base station to the mobile terminal, and the mobile terminal receives the SA sent by the antenna extending apparatus, and encrypts sent data and decrypts received data in a subsequent communication process by using the received SA.

212: The antenna extending apparatus acts as an agent of the mobile terminal, establishes an initial service flow with the base station, and obtains a new IP address and CID through the initial service flow.

Exemplarily, the antenna extending apparatus establishes a static transmission service flow and a dynamic transmission service flow with the base station, each transmission service flow is used for transmission of a communication service flow, and an initial service flow and a transmission service flow included in each service flow both correspond to a CID.

213: The antenna extending apparatus forwards the obtained new CID and IP address to the mobile terminal.

The foregoing steps 201 to 203 are a process of establishing an initial connection in the embodiment of the present invention, and after the initial connection is established, step 214 is performed.

Persons skilled in the art may learn that, in the signaling interaction process of steps 201 to 213, the mobile terminal may perform signaling transmission according to the CID allocated in step 206, and in a subsequent call process, namely, a data transmission process, data transmission needs to be performed by using the new CID and IP address that are obtained in step 213.

214: The mobile terminal initiates a call command to the antenna extending apparatus.

When the user of the mobile terminal initiates a call by using the mobile terminal, the mobile terminal initiates the call command to the antenna extending apparatus, and the mobile terminal uses the new IP address and CID as an identifier of a call initiated, encapsulates the identifier in the call command, and sends the call command to the antenna extending apparatus.

215: The antenna extending apparatus forwards the call command to the base station.

216: The antenna extending apparatus forwards a packet between the mobile terminal and the base station, so that the mobile terminal is capable of communicating with the base station through the antenna extending apparatus.

The process of step 216 may specifically include: encapsulating, by the mobile terminal, data by using the second security information, to obtain a first IP tunnel packet, and sending the first IP tunnel packet to the antenna extending apparatus through the IP tunnel; and when the antenna extending apparatus receives the first tunnel packet, decapsulating, by the antenna extending apparatus, the first tunnel packet, and sending data obtained after decapsulation to the base station.

When the base station has data required to be sent to the mobile terminal, the base station sends the data to the antenna extending apparatus, the antenna extending apparatus encapsulates the data, to obtain a second IP tunnel packet, the antenna extending apparatus sends the second IP tunnel packet to the mobile terminal through the IP tunnel, and the mobile terminal decapsulates the second IP tunnel packet, to obtain the data sent by the base station.

In a WiMAX network, the data in step 216 may be an air interface MAC frame.

It should be noted that, the mobile terminal at least has two wireless interfaces, namely, is in dual mode, which are referred to as a first interface and a second interface for ease of description, where the first interface is an interface for communication with a macro cellular network, for example, a WiMAX interface, and in a general case such as in an outdoor case, the mobile terminal is connected to the base station by using the first interface, and performs communication through a cellular network where the base station is located. The second interface is a WiFi interface, where the mobile terminal may be connected to the Internet through the second interface; and the antenna extending apparatus has two interfaces, which are referred to as an uplink interface and a downlink interface, where the downlink interface is connected to a home gateway, and may be a WiFi interface or an Ethernet interface, while the uplink interface is wirelessly connected to a base station of a macro network, and functions of the uplink interface are the same as the functions of the first interface of the mobile terminal. In this embodiment, the antenna extending apparatus establishes the IP tunnel with the second interface of the mobile terminal through the downlink interface.

In the method provided in this embodiment, the IP tunnel is established between the antenna extending apparatus, located in a country different from that of the mobile terminal, and the mobile terminal, so that the antenna extending apparatus uses the IP tunnel as a relay of communication between the mobile terminal and the base station, and therefore a signal of the base station logically extends abroad very well. Meanwhile, no complicated technology of interaction between heterogeneous networks needs to be used, communication quality is improved, and the problem that a mobile terminal, after being abroad, cannot directly interact with a domestic base station is solved.

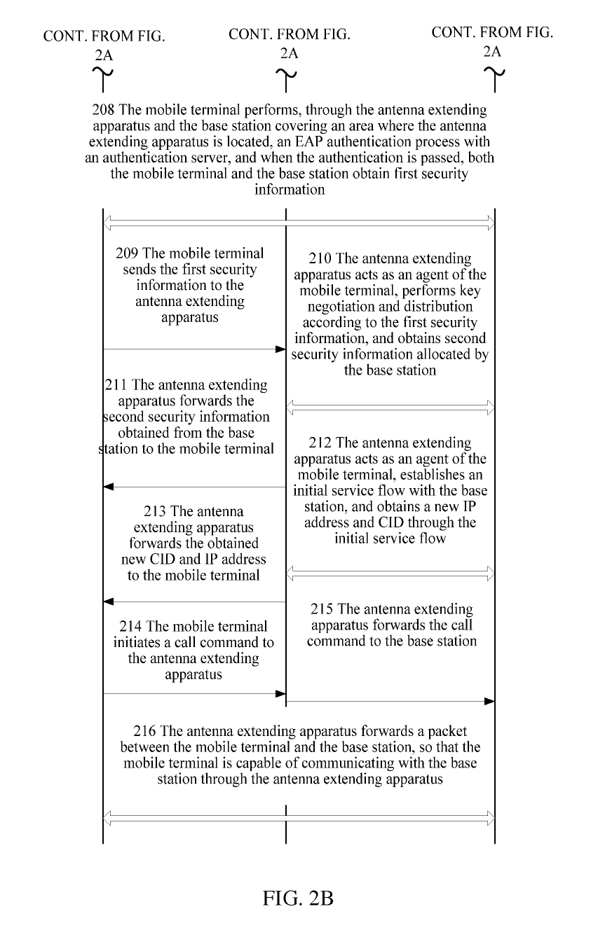

FIG. 3A and FIG. 3B are flowcharts of a communication method according to an embodiment of the present invention. Interactive bodies of this embodiment are a mobile terminal, an antenna extending apparatus, and a base station, where the mobile terminal and the antenna extending apparatus are located in different countries, for example, the antenna extending apparatus may be located in China, while the mobile terminal may be located outside China, and the base station refers to a base station covering an area where the antenna extending apparatus is located. The difference between this embodiment and the embodiment shown in FIG. 2A and FIG. 2B lies in that, after the mobile terminal obtains the first security information, in this embodiment, the mobile terminal, instead of the antenna extending apparatus as an agent, negotiates the second security information with the base station. Referring to FIG. 3A and FIG. 3B, this embodiment includes the following steps.

301: When receiving a connection command of a user, a mobile terminal establishes a network connection with a network in an area where the mobile terminal is located, and obtains a current IP address of the mobile terminal.

302: The mobile terminal sends a communication request to an antenna extending apparatus according to a preset IP address of the antenna extending apparatus, where the communication request carries the IP address of the mobile terminal.

303: The antenna extending apparatus establishes an IP tunnel with the mobile terminal according to the IP address of the mobile terminal and the IP address of the antenna extending apparatus.

304: The mobile terminal sends a terminal information packet to the antenna extending apparatus through the IP tunnel, where the terminal information packet carries terminal information.

305: The antenna extending apparatus performs initialization ranging according to a user identifier.

306: The antenna extending apparatus sends a basic CID obtained in an initial ranging process to the mobile terminal through the IP tunnel.

307: After completing the initialization ranging, the antenna extending apparatus sends a basic capability negotiation request to the base station, and performs basic capability negotiation with the base station, so that the base station is ready to attach to an ASN-GW, so as to notify the ASN-GW that a terminal is to perform initial network access.

308: The mobile terminal performs, through the antenna extending apparatus and the base station covering an area where the antenna extending apparatus is located, an EAP authentication process with an authentication server, and when the authentication is passed, both the mobile terminal and the base station obtain first security information.

The principle of steps 301 to 308 is the same as that of steps 201 to 208, and details are not described here again.

309: The mobile terminal performs key negotiation and distribution according to the first security information, and obtains second security information allocated by the base station.

310: The mobile terminal sends the second security information obtained from the base station to the antenna extending apparatus.

The difference between steps 309 to 310 and steps 209 to 211 lies in that, in steps 309 to 310, the mobile terminal performs the key negotiation and distribution with the base station according to the first security information, so that the mobile terminal obtains the second security information allocated by the base station, where the antenna extending apparatus does not need to act as an agent of the mobile terminal, and in this process, the antenna extending apparatus only performs tunnel transparent transmission and forwarding, and does not learn information transparently transmitted or forwarded by the antenna extending apparatus, while in steps 209 to 211, the antenna extending apparatus acts as the agent of the mobile terminal, obtains the second security information allocated by the base station, and sends the second security information to the mobile terminal. Compared with the embodiment shown in FIG. 2A and FIG. 2B, in the embodiment shown in FIG. 3A and FIG. 3B, because only the mobile terminal and the base station perform interaction to negotiate and obtain the security information, security is higher.

311: The antenna extending apparatus acts as the agent of the mobile terminal, establishes an initial service flow with the base station, and obtains a new IP address and CID through the initial service flow.

312: The antenna extending apparatus forwards the obtained new CID and IP address to the mobile terminal.

313: The mobile terminal initiates a call command to the antenna extending apparatus.

314: The antenna extending apparatus forwards the call command to the base station.

315: The antenna extending apparatus forwards a packet between the mobile terminal and the base station, so that the mobile terminal is capable of communicating with the base station through the antenna extending apparatus.

The principle of steps 311 to 315 is the same as that of steps 212 to 216, and details are not described here again.

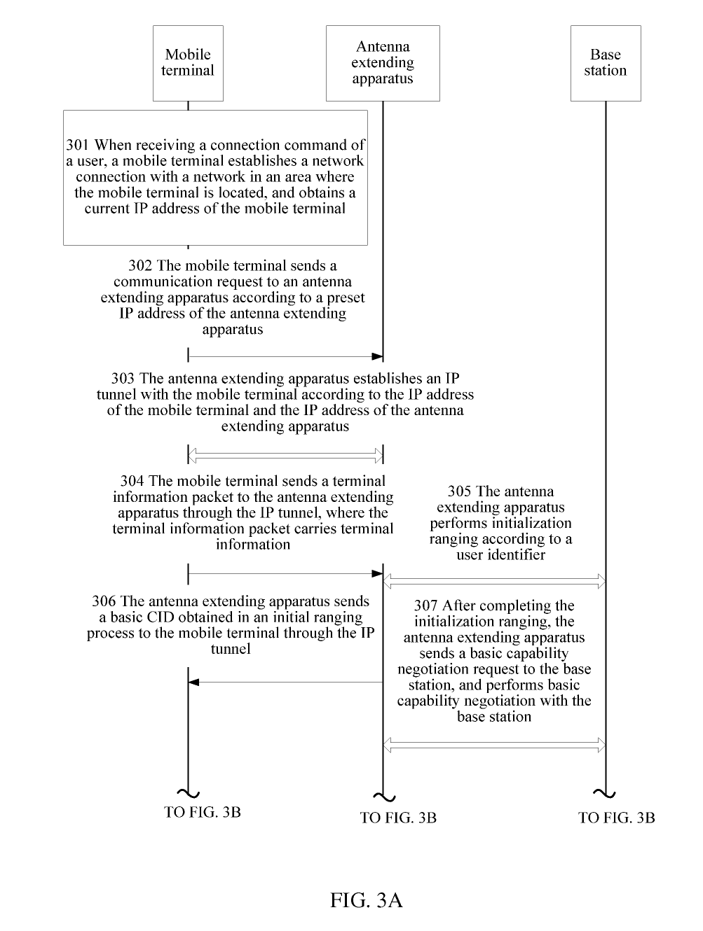

FIG. 4 is a flowchart of a communication method according to an embodiment of the present invention. The executive body of this embodiment is an interface extending apparatus. In this embodiment, a mobile terminal and the interface extending apparatus are located in different countries, the interface extending apparatus works as an abroad operation interface of the mobile terminal, and in use, a user may carry the interface extending apparatus abroad, and leave the mobile terminal at a domestic fixed place, so that the mobile terminal can obtain a fixed IP address, or the mobile terminal can be found through a fixed gateway, and therefore the interface extending apparatus can establish an IP tunnel with the mobile terminal. Referring to FIG. 4, this embodiment includes the following steps.

401: An interface extending apparatus receives a connection command.

The connection command is a command used to establish an IP tunnel between the interface extending apparatus and a mobile terminal.

In this embodiment, the interface extending apparatus is located abroad, and when a user intends to make a call from a foreign country to the home country of the user by using the interface extending apparatus, the user triggers the connection command, where the user may specifically trigger the connection command in any one of the following manners: (1) the interface extending apparatus provides an operation interface to the user, where the operation interface displays a “connect” option, and when it is detected that the user selects the “connect” option, the user triggers the connection command, and the interface extending apparatus receives the connection command; and (2) the user dials a number, and when the interface extending apparatus detects that the number dialed by the user is started with a specified area code, the connection command is triggered, and the interface extending apparatus receives the connection command, where the specified area code is an area code of an area where the mobile terminal is located.

402: The interface extending apparatus establishes an IP tunnel with the mobile terminal according to the connection command, so that after the IP tunnel is established, the mobile terminal completes an initial connection process with a base station in the area where the mobile terminal is located.

The user may activate the mobile terminal located domestically through a dialing action on the interface extending apparatus, so that the mobile terminal completes the initial connection process with the base station in the area where the mobile terminal is located, thereby avoiding interaction between the mobile terminal and an abroad network.

403: The interface extending apparatus sends a call command to the mobile terminal through the IP tunnel, so that the mobile terminal forwards the call command to the base station.

404: The interface extending apparatus communicates with the base station through the mobile terminal.

When the mobile terminal is set in traversal mode, the interface extending apparatus encrypts data according to first security information, encapsulates the encrypted data into a third IP tunnel packet, and sends the third IP tunnel packet to the mobile terminal through the IP tunnel, and then the mobile terminal decapsulates the third IP tunnel packet, and sends the encrypted data obtained after the decapsulation to the base station; when the interface extending apparatus receives a fourth IP tunnel packet sent by the mobile terminal, decapsulates the fourth IP tunnel packet, and decrypts the decapsulated data according to the first security information.

When the mobile terminal is set in gateway mode, the interface extending apparatus encapsulates data into a third IP tunnel packet, and sends the third IP tunnel packet to the mobile terminal through the IP tunnel, and then the mobile terminal decapsulates the third IP tunnel packet, encrypts the decapsulated data according to the first security information, and sends the encrypted data to the base station; when the mobile terminal receives data sent by the base station, decrypts the data according to the first security information, encapsulates the decrypted data into a fourth IP tunnel packet, and sends the fourth IP tunnel packet to the interface extending apparatus.

In the method provided in this embodiment, the mobile terminal and the interface extending apparatus are located in different countries, and the IP tunnel is established between the interface extending apparatus and the mobile terminal, so that the mobile terminal performs an initial connection process with the base station covering the mobile terminal; the mobile terminal communicates with the base station, and therefore the dialer of the mobile terminal logically extends abroad. Meanwhile, no complicated technology of interaction between heterogeneous networks needs to be used, communication quality is improved, and the problem that a mobile terminal, after being abroad, cannot directly interact with a domestic base station is solved.

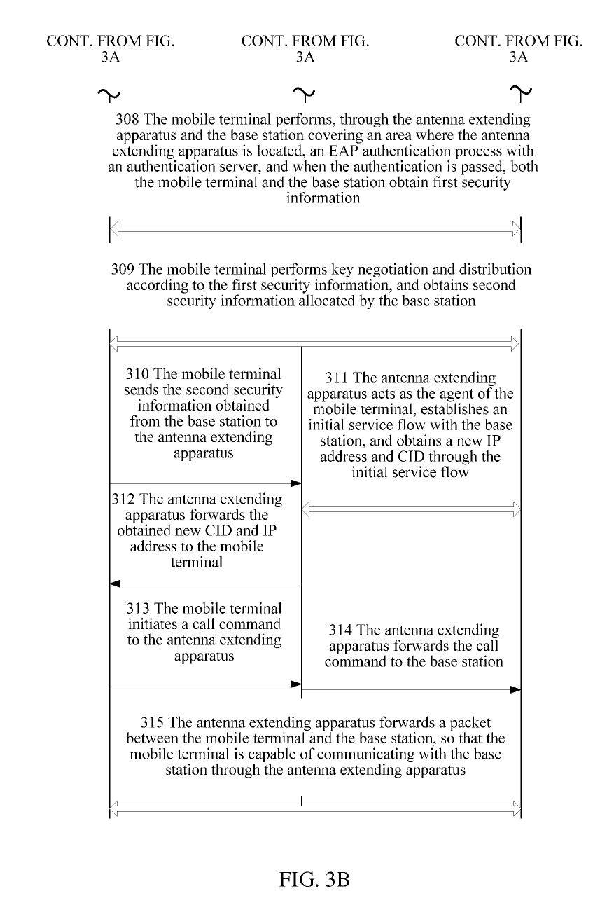

FIG. 5 is a flowchart of a communication method according to an embodiment of the present invention. Interactive bodies of this embodiment are an interface extending apparatus, a mobile terminal, and a base station in an area where the mobile terminal is located. In this embodiment, the mobile terminal and the interface extending apparatus are located in different countries, and the interface extending apparatus works as an abroad operation interface of the mobile terminal, and in use, a user may carry the interface extending apparatus abroad, and leave the mobile terminal at a domestic fixed place, so that the mobile terminal can obtain a fixed IP, or the mobile terminal can be found through a fixed gateway, and therefore the interface extending apparatus can establish an IP tunnel with the mobile terminal. Referring to FIG. 5, this embodiment includes the following steps.

501: When receiving a connection command of a user, an interface extending apparatus establishes a network connection with a network in an area where the interface extending apparatus is located, and obtains an IP address of the interface extending apparatus.

The principle of step 501 is similar to that of step 201, and the difference lies in that the executive body of step 501 is the interface extending apparatus.

502: The interface extending apparatus sends a communication request to a mobile terminal according to a preset IP address of the mobile terminal, where the communication request carries the IP address of the interface extending apparatus.

In this embodiment, the mobile terminal may be placed domestically. Exemplarily, the mobile terminal may be placed at the home or workplace of the user or other places, and is connected to the Internet through a home gateway; because the mobile terminal can obtain a fixed IP address, the fixed IP address of the mobile terminal is preset on an external device, so that the interface extending apparatus accesses the mobile terminal according to the fixed IP address. In this embodiment, the external device is an interface extending apparatus.

503: The mobile terminal establishes an IP tunnel with the interface extending apparatus according to the received IP address of the interface extending apparatus and the IP address of the mobile terminal.

In this embodiment, the interface extending apparatus establishes an IP tunnel with the mobile terminal, where one end of the tunnel is an IP address obtained by the interface extending apparatus through an AP or a local area network (LAN), while the other end of the tunnel is an IP address, obtained by the mobile terminal, of a home gateway. The IP tunnel may be an IPSec tunnel, and the IP tunnel is used to transmit all messages related to the WiMAX between the interface extending apparatus and the mobile terminal.

Exemplarily, before step 503, the method further includes: performing, by the mobile terminal, authentication with the home gateway of the network where the interface extending apparatus is located; and performing step 503 when the authentication is passed. The authentication may be performed by the interface extending apparatus according to a pre-stored password or key. The interface extending apparatus may be connected to the home gateway by searching for a domain name of the home gateway or a public network IP address of the home gateway. In this process, the interface extending apparatus may send an identifier (ID) or a MAC address to the home gateway, and after the authentication is passed, the interface extending apparatus can be connected to an in-home device.

504: The mobile terminal performs an initial connection process with a base station in an area where the mobile terminal is located, and obtains first security information.

It should be noted that, because the mobile terminal is located domestically all the time, the mobile terminal does not need an agent when establishing the initial connection process, where the initial connection process includes but not limited to: an initialization ranging process, a capability negotiation process, an authentication process, and a registration process. The initial connection process is the same as the initial connection process performed by the mobile terminal in the prior art, which is not described here again. Step 504 may be performed when the mobile terminal receives the communication request, or may be performed after the IP tunnel is established. In this embodiment, an example that step 504 is performed after the IP tunnel is established is only taken for description.

In addition, in the initial connection process performed by the mobile terminal with the base station, the mobile terminal obtains first security information allocated by the base station. Persons skilled in the art may learn that, the first security information is an AK, which is the same as security information obtained by the mobile terminal in the initial connection process in the prior art, and the usage and principle are also the same, which are not described here again.

505: The mobile terminal sends the first security information to the interface extending apparatus.

This embodiment is described by taking an example that the mobile terminal is set in traversal mode. In traversal mode, the mobile terminal sends the first security information to the interface extending apparatus, so that the interface extending apparatus encrypts data according to the first security information.

506: The interface extending apparatus sends a call command to the mobile terminal through the IP tunnel.

When the mobile terminal is set in traversal mode, the interface extending apparatus receives the first security information sent by the mobile terminal.

In this embodiment, the call command of the interface extending apparatus is triggered by dialing of the user, and the user can operate the interface extending apparatus in the same manner of operating the mobile terminal.

507: The mobile terminal receives the call command of the interface extending apparatus, and sends the call command to the base station.

In this embodiment, the mobile terminal acts as a relay between the interface extending apparatus and the base station to perform packet forwarding, where the packet forwarding includes forwarding a packet sent by the base station to the interface extending apparatus, and forwarding a packet sent by the interface extending apparatus to the base station.

508: The mobile terminal performs packet forwarding between the interface extending apparatus and the base station, so that the interface extending apparatus can communicate with the base station through the mobile terminal.

In traversal mode, the mobile terminal sends the first security information to the interface extending apparatus; when receiving a third IP tunnel packet sent by the interface extending apparatus, the mobile terminal decapsulates the third IP tunnel packet, and sends the encrypted data obtained after the decapsulation to the base station; and when receiving encrypted data sent by the base station, the mobile terminal encapsulates the encrypted data into a fourth IP tunnel packet, and sends the fourth IP tunnel packet to the interface extending apparatus. The mobile terminal is equivalent to a relay between the interface extending apparatus and the base station, and is configured to forward data of the base station and the interface extending apparatus.

In another embodiment, the mobile terminal may be further in gateway mode. In gateway mode, the mobile terminal does not send the first security information to the interface extending apparatus, but when receiving data from the base station, the mobile terminal decrypts the data according to the first security information, encapsulates the decrypted data into a fourth IP tunnel packet, and sends the fourth IP tunnel packet to the interface extending apparatus; when receiving a third IP tunnel packet sent by the interface extending apparatus, the mobile terminal decapsulates the third IP tunnel packet, encrypts the decapsulated data according to the first security information, and sends the encrypted data to the base station. At this time, the mobile terminal is equivalent to a gateway between the interface extending apparatus and the base station, and is further configured to encrypt or decrypt received data.

Exemplarily, to prevent a jitter phenomenon, when receiving a voice packet, the mobile terminal sends the voice packet to the base station after caching the voice packet, and when receiving downlink voice data, the interface extending apparatus plays the downlink voice data after caching the downlink voice data.

In the call process of the mobile terminal, the following examples may be taken: when a called party rings, the mobile terminal receives a signal and does not play a ringtone, but directly forwards the ringtone to the interface extending apparatus, so that the interface extending apparatus receives the ringtone forwarded by the mobile terminal; when the called party picks up, the mobile terminal does not pick up, and forwards an off-hook command to the interface extending apparatus, and the interface extending apparatus receives the off-hook command and picks up, and in this case, the interface extending apparatus establishes a call with the called party; when the called party hooks on, the mobile terminal receives an on-hook command, and forwards the on-hook command to the interface extending apparatus, and the interface extending apparatus receives the forwarded on-hook command, and hooks on, and in this case, communication ends.

In the method provided in this embodiment, the mobile terminal and the interface extending apparatus are located in different countries, and the IP tunnel is established between the interface extending apparatus and the mobile terminal, so that the mobile terminal performs the initial connection process with the base station covering the mobile terminal, and the mobile terminal communicates with the base station, and therefore the dialer of the mobile terminal logically extends abroad. Meanwhile, no complicated technology of interaction between heterogeneous networks needs to be used, communication quality is improved, and the problem that a mobile terminal, after being abroad, cannot directly interact with a domestic base station is solved.

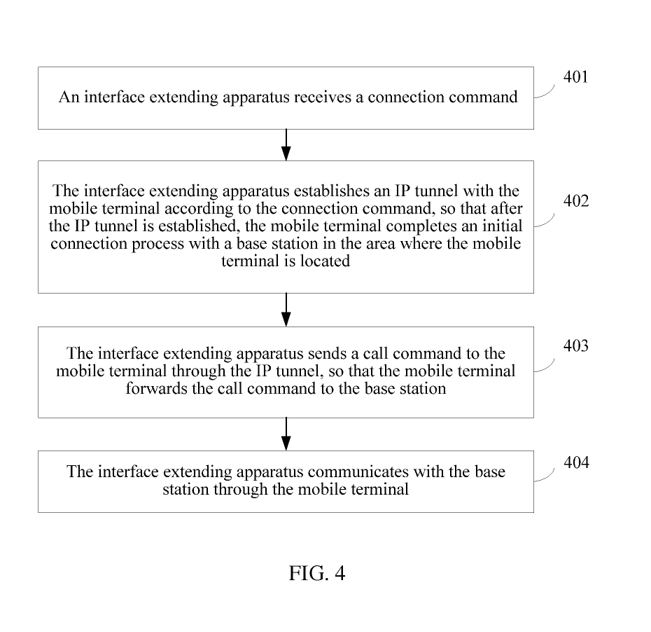

FIG. 6 is a schematic structural diagram of an antenna extending apparatus according to an embodiment of the present invention. Referring to FIG. 6, the apparatus includes: a receiving module 601 configured to receive a communication request from a mobile terminal; a tunnel establishing module 602 configured to establish an IP tunnel with the mobile terminal according to the communication request, where the receiving module 601 is further configured to receive terminal information sent through the IP tunnel by the mobile terminal; an initial connection module 603 configured to complete, according to the terminal information, an initial connection process with a base station covering an area where the antenna extending apparatus is located; and a forwarding module 604 configured to forward a packet between the mobile terminal and the base station, so that the mobile terminal is capable of communicating with the base station through the antenna extending apparatus.

Optionally, the terminal information includes a user identifier and terminal capability information, and completing an initial connection process includes: initialization ranging and basic capability negotiation.

Correspondingly, the initial connection module 603 includes: an initialization ranging unit configured to send an initial ranging request to the base station, and receive an initial ranging response sent by the base station, where the initial ranging request carries the user identifier, and the initial ranging response carries a basic CID allocated by the base station to the terminal; and a capability negotiation unit configured to send a basic capability negotiation request to the base station, and perform basic capability negotiation with the base station, where the basic capability negotiation request carries the basic CID and the terminal capability information.

Optionally, the forwarding module 604 is specifically configured to: when a first IP tunnel packet is received from the mobile terminal, decapsulate the first IP tunnel packet, to obtain first data encapsulated in the first IP tunnel packet, and send the first data to the base station; and when second data of the base station is received, encapsulate the second data into a second IP tunnel packet, and forward the second IP tunnel packet to the mobile terminal.

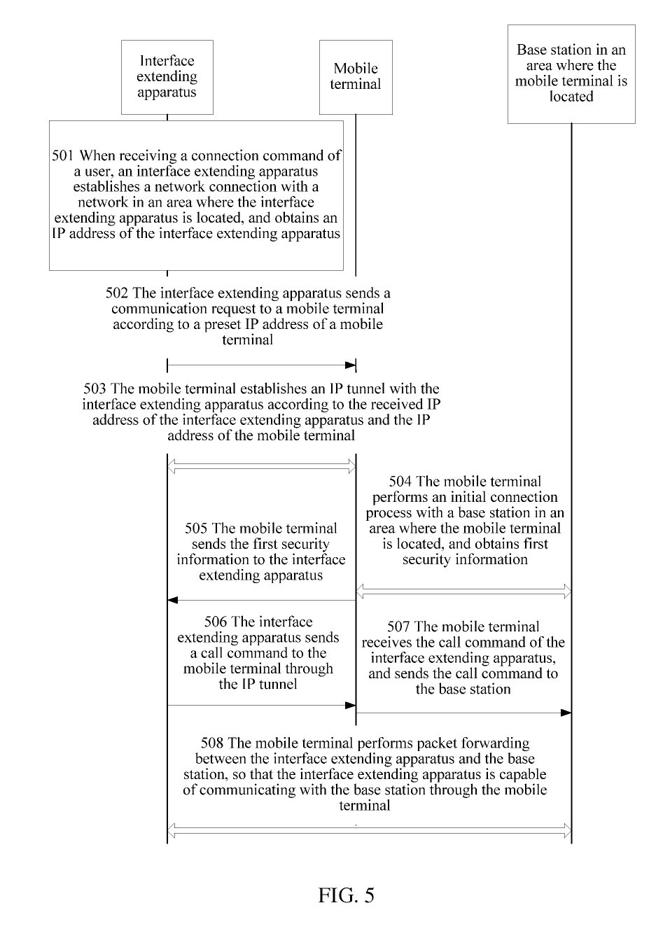

FIG. 7 is a schematic structural diagram of a mobile terminal according to an embodiment of the present invention. Referring to FIG. 7, the mobile terminal includes: a sending module 701 configured to send a communication request to an antenna extending apparatus according to a preset IP address of the antenna extending apparatus; a tunnel establishing module 702 configured to establish an IP tunnel with the antenna extending apparatus according to the communication request, where the sending module 701 is further configured to send terminal information to the antenna extending apparatus through the IP tunnel, so that the antenna extending apparatus completes initialization ranging and basic capability negotiation processes according to the terminal information; an authentication module 703 configured to perform, through the antenna extending apparatus, authentication with a base station covering an area where the antenna extending apparatus is located; and a communication module 704 configured to communicate with the base station through the antenna extending apparatus after the authentication is passed.

The mobile terminal further includes: an identity authentication module 705 configured to perform connection and authentication with a home gateway.

Optionally, the authentication module 703 is specifically configured for the mobile terminal to perform, through the antenna extending apparatus, authentication with the base station covering the area where the antenna extending apparatus is located, and after the authentication is passed, obtain first security information, and send the obtained first security information to the antenna extending apparatus, so that the antenna extending apparatus is capable of acting as an agent of the mobile terminal to perform key negotiation and distribution.

Optionally, the mobile terminal is further configured to receive second security information sent by the antenna extending apparatus, where the second security information is used to encrypt sent data and decrypt received data in a communication process.

The communication module 704 is specifically configured to: when there is data to be sent to the base station, encrypt and encapsulate the data according to the second security information, to obtain a first IP tunnel packet, and send the first IP tunnel packet to the antenna extending apparatus; and when a second IP tunnel packet sent by the antenna extending apparatus is received, decapsulate and decrypt the second IP tunnel packet according to the second security information.

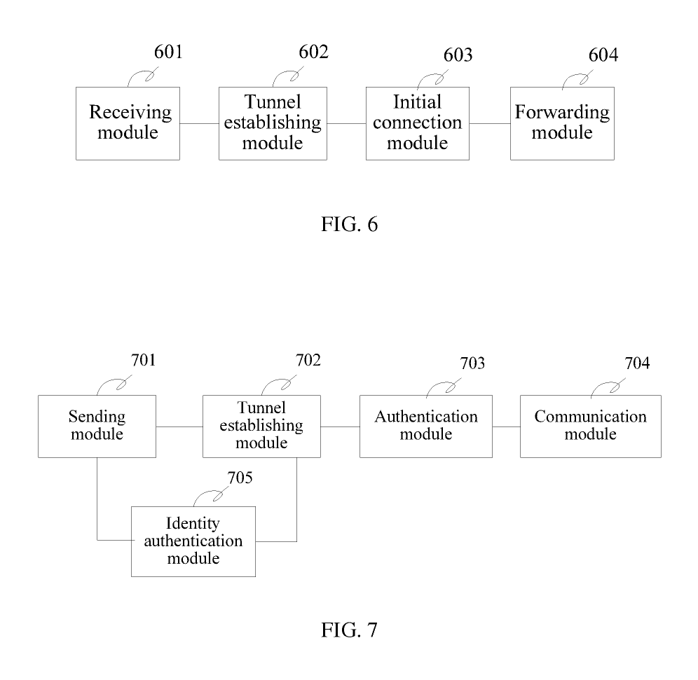

FIG. 8 is a schematic structural diagram of an interface extending apparatus according to an embodiment of the present invention. Referring to FIG. 8, the interface extending apparatus includes: a receiving module 801 configured to receive a connection command; a tunnel establishing module 802 configured to establish an IP tunnel with a mobile terminal according to the connection command, so that after the IP tunnel is established, the mobile terminal completes an initial connection process with a base station in an area where the mobile terminal is located; a call module 803 configured to send a call command to the mobile terminal through the IP tunnel, so that the mobile terminal forwards the call command to the base station; and a communication module 804 configured to communicate with the base station through the mobile terminal.

Optionally, the interface extending apparatus is further configured to receive first security information sent by the mobile terminal.

Correspondingly, the communication module 804 is specifically configured to communicate with the base station through the mobile terminal according to the first security information.

Optionally, the communication module 804 is specifically configured to encrypt data according to the first security information, encapsulate the encrypted data into a third IP tunnel packet, and send the third IP tunnel packet to the mobile terminal through the IP tunnel, and then the mobile terminal decapsulates the third IP tunnel packet, and sends the encrypted data obtained after the decapsulation to the base station; and when a fourth IP tunnel packet sent by the mobile terminal is received, decapsulate the fourth IP tunnel packet, and decrypt the decapsulated data according to the first security information.

Optionally, the communication module 804 is specifically configured to encapsulate data into a third IP tunnel packet, and send the third IP tunnel packet to the mobile terminal through the IP tunnel, and then the mobile terminal decapsulates the third IP tunnel packet, encrypts the decapsulated data according to the first security information, and sends the encrypted data to the base station; and when receiving data sent by the base station, the mobile terminal decrypts the data according to the first security information, encapsulates the decrypted data into a fourth IP tunnel packet, and sends the fourth IP tunnel packet to the interface extending apparatus.

Optionally, the interface extending apparatus further includes: a cache module configured to: when downlink voice data is received, play the downlink voice data after caching the downlink voice data.

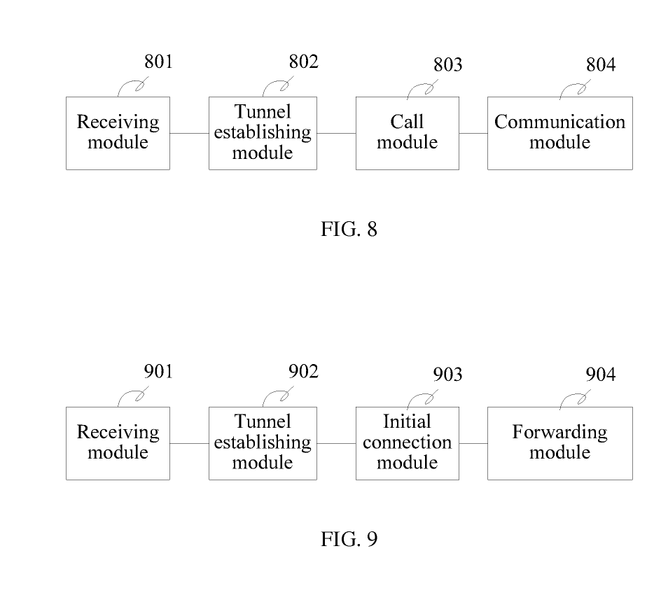

FIG. 9 is a schematic structural diagram of a mobile terminal according to an embodiment of the present invention. Referring to FIG. 9, the mobile terminal includes: a receiving module 901 configured to receive a communication request from an interface extending apparatus; a tunnel establishing module 902 configured to establish an IP tunnel with the interface extending apparatus according to the communication request; an initial connection module 903 configured to complete an initial connection process with a base station in an area where the mobile terminal is located; and a forwarding module 904 configured to perform packet forwarding between the interface extending apparatus and the base station, so that the interface extending apparatus is capable of communicating with the base station through the mobile terminal.

Optionally, in the initial connection process, the mobile terminal obtains first security information allocated by the base station.

Correspondingly, the forwarding module 904 is specifically configured to: when a third IP tunnel packet sent by the interface extending apparatus is received, decapsulate the third IP tunnel packet, and send the encrypted data obtained after the decapsulation to the base station; and when the encrypted data sent by the base station is received, encapsulate the encrypted data into a fourth IP tunnel packet, and send the fourth IP tunnel packet to the interface extending apparatus.

The forwarding module 904 is specifically configured to: when data from the base station is received, decrypt the data according to the first security information, encapsulate the decrypted data into a fourth IP tunnel packet, and send the fourth IP tunnel packet to the interface extending apparatus; and when a third IP tunnel packet sent by the interface extending apparatus is received, decapsulate the third IP tunnel packet, encrypt the decapsulated data according to the first security information, and send the encrypted data to the base station.

Optionally, the mobile terminal further includes: a cache module configured to: when a voice packet is received, cache the voice packet.

Persons of ordinary skill in the art may understand that all or a part of the steps of the foregoing embodiments may be implemented through hardware, or may be implemented by a program instructing relevant hardware. The program may be stored in a computer readable storage medium. The storage medium may be a read-only memory, a magnetic disk, an optical disk or the like.

The foregoing description is merely about exemplary embodiments of the present invention, but is not intended to limit the present invention. Any modification, equivalent replacement or improvement made within the principle of the present invention shall all fall within the protection scope of the present invention.

What is claimed is:

1. A communication method, comprising:
receiving, by an antenna extending apparatus, a communication request from a mobile terminal;
establishing, by the antenna extending apparatus, an Internet Protocol (IP) tunnel with the mobile terminal according to the communication request;
receiving, by the antenna extending apparatus, terminal information sent through the IP tunnel by the mobile terminal;
completing, by the antenna extending apparatus according to the terminal information, an initial connection process with a base station covering an area where the antenna extending apparatus is located; and
forwarding, by the antenna extending apparatus, a packet between the mobile terminal and the base station such that the mobile terminal is capable of communicating with the base station through the antenna extending apparatus.

2. The method according to claim 1, wherein the terminal information comprises a user identifier and terminal capability information, and wherein completing the initial connection process comprises initialization ranging and basic capability negotiation, wherein the initialization ranging comprises sending, by the antenna extending apparatus, an initial ranging request to the base station, and receiving an initial ranging response sent by the base station, wherein the initial ranging request carries the user identifier, and the initial ranging response carries a basic connection identifier (CID) allocated by the base station to the terminal, and wherein the basic capability negotiation comprises sending, by the antenna extending apparatus, a basic capability negotiation request to the base station, and performing basic capability negotiation with the base station, wherein the basic capability negotiation request carries the basic CID and the terminal capability information.

3. The method according to claim 1, wherein completing, by the antenna extending apparatus according to the terminal information, the initial connection process with the base station covering the area where the antenna extending apparatus is located such that the mobile terminal is capable of communicating with the base station through the antenna extending apparatus comprises:
when receiving a first IP tunnel packet from the mobile terminal, decapsulating the first IP tunnel packet to obtain first data encapsulated in the first IP tunnel packet, and sending the first data to the base station; and
when receiving second data of the base station, encapsulating the second data into a second IP tunnel packet, and forwarding the second IP tunnel packet to the mobile terminal.

4. A communication method, comprising:
sending, by a mobile terminal, a communication request to an antenna extending apparatus according to a preset Internet Protocol (IP) address of the antenna extending apparatus;
establishing, by the antenna extending apparatus, an IP tunnel with the mobile terminal according to the communication request;
sending, by the mobile terminal, terminal information to the antenna extending apparatus through the IP tunnel such that the antenna extending apparatus completes initialization ranging and basic capability negotiation processes according to the terminal information;
performing, by the mobile terminal, through the antenna extending apparatus, authentication with a base station covering an area where the antenna extending apparatus is located; and
communicating with the base station through the antenna extending apparatus after the authentication is passed.

5. The method according to claim 4, wherein before establishing, by the antenna extending apparatus, the IP tunnel with the mobile terminal, the method comprises performing, by the mobile terminal, connection and authentication with a home gateway, and wherein correspondingly, establishing, by the antenna extending apparatus, the IP tunnel with the mobile terminal specifically comprises when the authentication performed by the mobile terminal with the home gateway is passed, establishing, by the mobile terminal, an IP tunnel with the antenna extending apparatus.

6. The method according to claim 4, wherein performing, by the mobile terminal, through the antenna extending apparatus, authentication with the base station covering the area where the antenna extending apparatus is located, and communicating with the base station through the antenna extending apparatus after the authentication is passed comprises performing, by the mobile terminal, through the antenna extending apparatus, authentication with the base station covering the area where the antenna extending apparatus is located, and after the authentication is passed, obtaining first security information, and sending the obtained first security information to the antenna extending apparatus such that the antenna extending apparatus is capable of acting as an agent of the mobile terminal to perform key negotiation and distribution.

7. The method according to claim 6, wherein after performing, by the mobile terminal, through the antenna extending apparatus, authentication with the base station covering the area where the antenna extending apparatus is located, and after the authentication is passed, obtaining the first security information, and sending the obtained first security information to the antenna extending apparatus, the method comprises receiving, by the mobile terminal, second security information sent by the antenna extending apparatus, wherein the second security information is used to encrypt sent data and decrypt received data in a communication process.

8. The method according to claim 7, wherein after receiving, by the mobile terminal, the second security information sent by the antenna extending apparatus, the method comprises:
when there is data to be sent to the base station, encrypting and encapsulating the data according to the second security information to obtain a first IP tunnel packet, and sending the first IP tunnel packet to the antenna extending apparatus; and
when receiving a second IP tunnel packet sent by the antenna extending apparatus, decapsulating and decrypting the second IP tunnel packet according to the second security information.

9. An antenna extending apparatus, comprising:
a receiving module configured to receive a communication request from a mobile terminal;
a tunnel establishing module configured to establish an Internet Protocol (IP) tunnel with the mobile terminal according to the communication request, wherein the receiving module is further configured to receive terminal information sent through the IP tunnel by the mobile terminal;
an initial connection module configured to complete, according to the terminal information, an initial connection process with a base station covering an area where the antenna extending apparatus is located; and
a forwarding module configured to forward a packet between the mobile terminal and the base station such that the mobile terminal is capable of communicating with the base station through the antenna extending apparatus.

10. The antenna extending apparatus according to claim 9, wherein the terminal information comprises a user identifier and terminal capability information, wherein completing the initial connection process comprises initialization ranging and basic capability negotiation, wherein correspondingly, the initial connection module comprises an initialization ranging unit and a capability negotiation unit, wherein the initialization ranging unit is configured to send an initial ranging request to the base station, and receive an initial ranging response sent by the base station, wherein the initial ranging request carries the user identifier, and the initial ranging response carries a basic connection identifier (CID) allocated by the base station to the terminal, and wherein the capability negotiation unit is configured to send a basic capability negotiation request to the base station, and perform basic capability negotiation with the base station, wherein the basic capability negotiation request carries the basic CID and the terminal capability information.

11. The antenna extending apparatus according to claim 9, wherein the forwarding module is configured to:
when a first IP tunnel packet is received from the mobile terminal, decapsulate the first IP tunnel packet to obtain first data encapsulated in the first IP tunnel packet, and send the first data to the base station; and
when second data of the base station is received, encapsulate the second data into a second IP tunnel packet, and forward the second IP tunnel packet to the mobile terminal.

12. A mobile terminal, comprising:
a sending module configured to send a communication request to an antenna extending apparatus according to a preset Internet Protocol (IP) address of the antenna extending apparatus;
a tunnel establishing module configured to establish an IP tunnel with the antenna extending apparatus according to the communication request, wherein the sending module is further configured to send terminal information to the antenna extending apparatus through the IP tunnel such that the antenna extending apparatus completes initialization ranging and basic capability negotiation processes according to the terminal information;
an authentication module configured to perform, through the antenna extending apparatus, authentication with a base station covering an area where the antenna extending apparatus is located; and
a communication module configured to communicate with the base station through the antenna extending apparatus after the authentication is passed.

13. The mobile terminal according to claim 12, wherein the mobile terminal further comprises an identity authentication module configured to perform connection and authentication with a home gateway.

14. The mobile terminal according to claim 12, wherein the authentication module is configured for the mobile terminal to perform, through the antenna extending apparatus, authentication with the base station covering the area where the antenna extending apparatus is located, and after the authentication is passed, obtain first security information, and send the obtained first security information to the antenna extending apparatus such that the antenna extending apparatus is capable of acting as an agent of the mobile terminal to perform key negotiation and distribution.

15. The mobile terminal according to claim 14, wherein the mobile terminal is further configured to receive second security information sent by the antenna extending apparatus, wherein the second security information is used to encrypt sent data and decrypt received data in a communication process.

16. The mobile terminal according to claim 15, wherein the communication module is configured to:
when there is data to be sent to the base station, encrypt and encapsulate the data according to the second security information to obtain a first IP tunnel packet, and send the first IP tunnel packet to the antenna extending apparatus; and
when a second IP tunnel packet sent by the antenna extending apparatus is received, decapsulate and decrypt the second IP tunnel packet according to the second security information.

17. An interface extending apparatus, comprising:
a receiving module configured to receive a connection command;
a tunnel establishing module configured to establish an Internet Protocol (IP) tunnel with a mobile terminal according to the connection command such that after the IP tunnel is established, the mobile terminal completes an initial connection process with a base station in an area where the mobile terminal is located;
a call module configured to send a call command to the mobile terminal through the IP tunnel such that the mobile terminal forwards the call command to the base station; and
a communication module configured to communicate with the base station through the mobile terminal.

18. The interface extending apparatus according to claim 17, wherein the interface extending apparatus is further configured to receive first security information sent by the mobile terminal, and wherein the communication module is specifically configured to communicate with the base station through the mobile terminal according to the first security information.

19. The interface extending apparatus according to claim 18, wherein the communication module is specifically configured to:
encrypt data according to the first security information, encapsulate the encrypted data into a third IP tunnel packet, and send the third IP tunnel packet to the mobile terminal through the IP tunnel, and then the mobile terminal decapsulates the third IP tunnel packet, and sends the encrypted data obtained after the decapsulation to the base station; and
when a fourth IP tunnel packet sent by the mobile terminal is received, decapsulate the fourth IP tunnel packet, and decrypt the decapsulated data according to the first security information.

20. The interface extending apparatus according to claim 18, wherein the communication module is specifically configured to:
encapsulate data into a third IP tunnel packet, and send the third IP tunnel packet to the mobile terminal through the IP tunnel, and then the mobile terminal decapsulates the third IP tunnel packet, encrypts the decapsulated data according to the first security information, and sends the encrypted data to the base station; and
when receiving data sent by the base station, the mobile terminal decrypts the data according to the first security information, encapsulates the decrypted data into a fourth IP tunnel packet, and sends the fourth IP tunnel packet to the interface extending apparatus.

21. A mobile terminal, comprising:
a receiving module configured to receive a communication request from an interface extending apparatus;
a tunnel establishing module configured to establish an Internet Protocol (IP) tunnel with the interface extending apparatus according to the communication request;
an initial connection module configured to complete an initial connection process with a base station in an area where the mobile terminal is located; and
a forwarding module configured to perform packet forwarding between the interface extending apparatus and the base station such that the interface extending apparatus is capable of communicating with the base station through the mobile terminal.

22. The mobile terminal according to claim 21, wherein the mobile terminal obtains first security information allocated by the base station, wherein the forwarding module is specifically configured to when a third IP tunnel packet sent by the interface extending apparatus is received, decapsulate the third IP tunnel packet, and send the encrypted data obtained after the decapsulation to the base station, and when the encrypted data sent by the base station is received, encapsulate the encrypted data into a fourth IP tunnel packet, and send the fourth IP tunnel packet to the interface extending apparatus, and wherein the forwarding module is specifically configured to when data from the base station is received, decrypt the data according to the first security information, encapsulate the decrypted data into a fourth IP tunnel packet, and send the fourth IP tunnel packet to the interface extending apparatus, and when a third IP tunnel packet sent by the interface extending apparatus is received, decapsulate the third IP tunnel packet, encrypt the decapsulated data according to the first security information, and send the encrypted data to the base station.
